(19) United States
(12) Patent Application Publication
(10) Pub. No.: US 2018/0306331 A1
(43) Pub. Date: Oct. 25, 2018

(54) Regulator Seal Assembly

(71) Applicant: TESCOM CORPORATION, Elk River, MN (US)

(72) Inventors: Brian J. Tutt, Brainerd, MN (US); Zhang Yingchun, Shanghai (CN)

(73) Assignee: TESCOM CORPORATION, Elk River, MN (US)

(21) Appl. No.: 15/767,982

(22) PCT Filed: Oct. 11, 2016
(86) PCT No.: PCT/US2016/056422

§ 371 Date: Apr. 12, 2018

(30) Foreign Application Priority Data
Oct. 12, 2015 (CN) 201510659152.7
Oct. 12, 2015 (CN) 201520788437.6

(51) Int. Cl. F16K 1/46

(52) U.S. Cl. CPC F16K 1/465; G05D 16/0666

(57) ABSTRACT

A fluid regulator includes a regulator body, a retainer, and a cartridge. The regulator body defines a fluid inlet, a fluid outlet, a fluid flow path connecting the fluid inlet to the fluid outlet, and an opening disposed in communication with the fluid flow path. The retainer is at least partially disposed within the opening of the regulator body and has a central bore extending along a longitudinal axis thereof and a counterbore formed along an end of the central bore. The cartridge is adapted to be at least partially disposed within the central bore of the retainer along the central longitudinal axis and comprises an end portion having a surface extending radially from the central longitudinal axis. Upon the cartridge being at least partially disposed within the central bore of the retainer, the counterbore of the retainer and the surface of the cartridge form a connecting groove.

### FIELD OF THE DISCLOSURE

The present disclosure generally relates to a seal assembly for a regulator and, more particularly, to a separated dove-tail groove design which is formed by surfaces on a cartridge and a retainer.

### BACKGROUND

Process fluid regulators are used in myriad industrial and residential applications for controlling the downstream pressure of a fluid. For example, in chemical processing plants or oil refineries, pressure regulating valves are used to manipulate a flowing fluid to compensate for increases or decreases in demand, or other load disturbances, and thus keep the fluid pressure regulated. Similarly, pressure regulating valves may be used in plumbing fixtures to maintain a pre-determined pressure of fluid that automatically adjusts to variations in demand, such as anti-scald valves in showers or faucets. Most end-user facilities equipped with gas appliances such as furnaces, ovens, etc., require the gas to be delivered in accordance with a predetermined pressure, and at or below a maximum capacity of the end-user appliance. Therefore, process fluid regulators are implemented in these distribution systems in order to ensure that the delivered gas meets the requirements of the end-user facilities.

Fluid cartridge assemblies may include a cartridge and a retainer, among numerous additional components. The retainer may include a groove or grooves which a sealing member may be inserted into to create a seal with a diaphragm component. One common groove design is a dove tail groove which includes a pair of tapered sidewalls forming a mortise. Due to the dove tail geometry, expensive, special groove tools are required which may substantially increase manufacturing costs. Further, because these dove tail grooves typically have small dimensions, they may be difficult to be machined from conventional materials using conventional methods. As such, the retainer may be needed to be constructed of expensive materials able to be machined with greater ease, which in turn may further increase manufacturing costs.

### BRIEF DESCRIPTION OF THE DRAWINGS

The above needs are at least partially met through provision of the regulator seal assembly described in the following detailed description, particularly when studied in conjunction with the drawings, wherein:

FIG. 1 illustrates a cross-sectional view of a fluid regulator having a separated dove-tail groove design in accordance with various embodiments of the invention;

FIG. 2 illustrates a perspective view of the cartridge assembly of the exemplary fluid regulator of FIG. 1 in accordance with various embodiments of the invention; and

FIG. 3 illustrates a cross-sectional view of the cartridge assembly of the exemplary fluid regulator of FIGS. 1 and 2 in accordance with various embodiments of the invention

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### SUMMARY

Generally speaking, pursuant to these various embodiments, systems and approaches for a regulator seal assembly are provided and may include a fluid regulator includes a regulator body, a retainer, and a cartridge. The regulator body defines a fluid inlet, a fluid outlet, a fluid flow path connecting the fluid inlet to the fluid outlet, and an opening disposed in communication with the fluid flow path. The retainer is at least partially disposed within the opening of the regulator body and has a central bore extending along a longitudinal axis thereof and a counterbore formed along an end of the central bore. The cartridge is adapted to be at least partially disposed within the central bore of the retainer along the central longitudinal axis and comprises an end portion having a surface extending radially from the central longitudinal axis. Upon the cartridge being at least partially disposed within the central bore of the retainer, the counterbore of the retainer and the surface of the cartridge form a connecting groove.

In some approaches, the connecting groove may comprise a dovetail groove having an inner tapered projection and an outer tapered projection. The counterbore of the retainer may comprise a first surface and a second surface, whereby an angle formed between the surfaces is acute. The fluid regulator may also include a packing member which is adapted to be at least partially disposed within the connecting groove to act as a seal.

The surface of the cartridge may comprise an exterior surface that is either planar, arcuate, or a combination thereof. The surface extending radially from the central longitudinal axis may form an acute angle with the central longitudinal axis. In some embodiments, the end portion of the cartridge may form a generally bevelled edge.

In other approaches, a regulator cartridge assembly includes a retainer and a cartridge. In these approaches, the retainer may have a central bore extending along a longitudinal axis thereof and a notch surrounding an outer edge thereof. The cartridge is adapted to be at least partially disposed within the retainer along the central longitudinal axis via the central bore and may comprise an end portion having a surface protruding radially from the central longitudinal axis. The notch of the retainer and the surface of the cartridge are adapted to form a recessed area.

In some embodiments, the recessed area comprises a groove having inwardly-tapered walls. In other approaches, the end portion of the cartridge forms a generally bevelled edge. In some of these embodiments, the regulator cartridge assembly may further comprise a toric joint adapted to be at least partially disposed within the recessed area.

In still other aspects, a regulator body is provided which defines a fluid inlet, a fluid outlet, a fluid flow path connecting the fluid inlet to the fluid outlet, and an opening disposed in communication with the fluid flow path. A retainer is also provided which has a central bore extending along a longitudinal axis thereof and a counterbore formed along a first end of the central bore. In some examples, a counterbore is formed which has a tapered sidewall. A cartridge is also provided which has an end portion having a surface extending radially from the central longitudinal axis. In some examples, a generally beveled edge is formed on the end portion thereof.

The retainer is at least partially disposed within the opening of the regulator body and the cartridge is at least partially disposed within the central bore of the retainer such that the counterbore of the retainer and the surface of the cartridge form a connecting groove. In some of these approaches, a packing member may be disposed in the connecting groove to form a seal.

So configured, a separate dove tail groove is formed where the inner features of the groove are formed on the retainer, and the outer features of the groove are formed on the cartridge. Such a configuration may be machined from conventional materials via conventional machinery and methods thereby reducing manufacturing costs.

### DETAILED DESCRIPTION

Referring now to the drawings, a process fluid regulator 100 is provided. The regulator 100 includes a regulator body 102 having a fluid inlet 104 and a fluid outlet 106. In an embodiment, the regulator body 102 may be capable of housing a typical balanced or unbalanced valve cartridge. A bonnet 108 houses a load spring 110 and a set point adjusting mechanism 112. A balanced cartridge assembly 150 is located within the valve body 102 between the fluid inlet 104 and the fluid outlet 106 to regulate downstream fluid pressure.

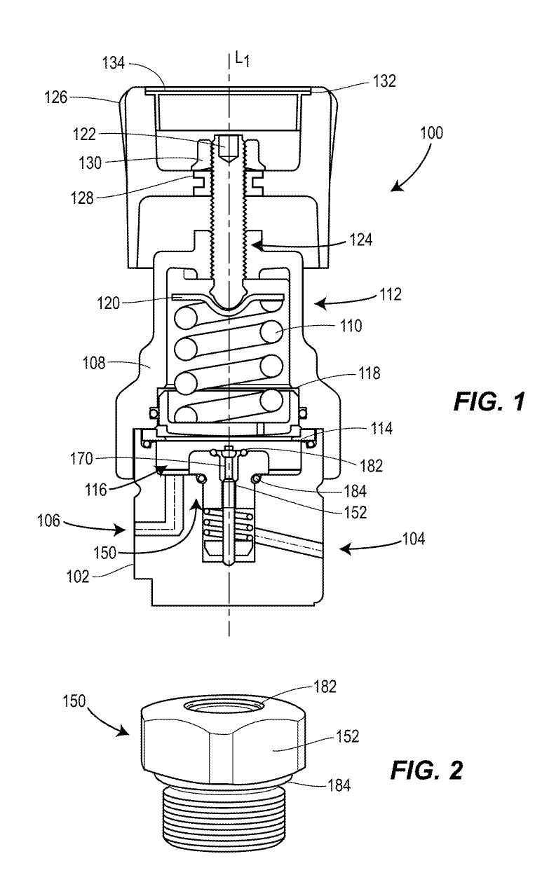

The regulator 100 further includes a diaphragm 114 that is responsive to downstream pressure in chamber or opening 116. The diaphragm 114 is movable within the bonnet 108. As illustrated in FIG. 1, the diaphragm 114 is movable along a central longitudinal axis L1 and is located at a position in which force on the diaphragm 114 generated by the outlet fluid pressure in the opening 116 is balanced with a force on the diaphragm 114 generated by the load spring 110. The diaphragm 114 may be supported and/or reinforced by a diaphragm plate 54. The diaphragm plate 54 both supports the diaphragm 114 and acts as a force transfer mechanism to transfer force from the load spring 110 to the diaphragm 114. The load spring 110 seats between the diaphragm plate 118 and a spring button 120. An adjustment screw 122 is disposed in an opening 124 in the bonnet 108. The adjustment screw 122 is displaceable within the opening 124 such that one end of the adjustment screw 122 abuts the spring button 120. Movement of the adjustment screw 122 moves the location of the spring button 120 within the bonnet 108 and thus, the spring force acting on the diaphragm plate 118 from the load spring 110 may be modified. In this manner, a set point of the regulator 100 may be adjusted.

To facilitate adjustment of the adjustment screw 122, the adjustment screw 122 may be connected to a hand knob 126 by a hand knob insert 128 and a nut 130. Access to the nut 130 may be available through an opening 132 in the hand knob 126, which may be covered by a hole plug 134.

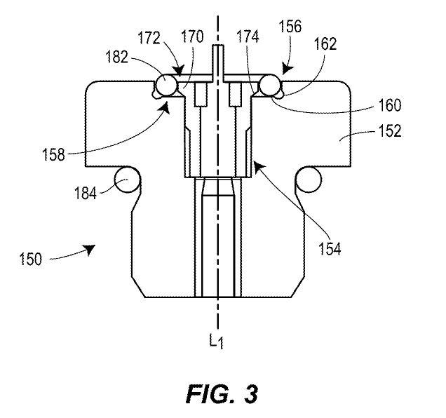

FIGS. 2 and 3 illustrate an exemplary cartridge assembly 150. It is understood that the cartridge assembly 150 may include any number of additional components and/or structures (e.g., bores, caps, threaded connections, plugs, stems, springs, and the like) which may assist in its operation but will not be described in substantial detail for the sake of brevity. The cartridge assembly 150 may include a retainer 152 and a cartridge 170. The regulator body 102 described with reference to FIG. 1 further defines a fluid flow path connecting the fluid inlet 104 to the fluid outlet 106, whereby the opening 116 is disposed in communication therewith. The retainer 152 is at least partially disposed within the opening 116 of the regulator body 102 and has a central bore 154 extending along a longitudinal axis L1 thereof and a counterbore 158 or notch formed along an end 156 of the central bore 154. In some examples, the counterbore 158 may surround an outer edge of the central bore 154. the counterbore forms surfaces 160, 162 which may intersect at a point, a curve, or any other suitable configuration. In an exemplary embodiment, the angle formed between the first surface and the second surface 160, 162 is acute.

The cartridge 170 is adapted to be at least partially disposed within the central bore 154 of the retainer 152 along the central longitudinal axis L1 and comprises an end portion 172 having a surface 174 which may be an exterior surface that extending and/or protruding radially from the central longitudinal axis L1. Upon the cartridge 170 being at least partially disposed within the central bore 154 of the retainer 150, the counterbore 158 of the retainer 150 and the surface 174 of the cartridge 170 form a recessed area such as, for example, connecting groove.

In some examples, the surfaces 162, 174 form the sidewalls of the recessed area. The surfaces may be planar, arcuate, or any combination thereof. In an exemplary embodiment, the surface 174 extending radially from the central longitudinal axis L1 forms an acute angle therewith such that the surface 174 extends in a direction into the recessed area. The end portion 172 may also form a generally bevelled edge. As illustrated in FIG. 3, the resulting cross-sectional shape of the recessed area may generally form a dovetail groove. In other words, the recessed area may have inwardly-tapered walls. It is understood that either one or both of the surfaces 162, 174 may be inwardly tapered.

Because the recessed area is formed by a combination of the retainer 152 and the cartridge 170, conventional tools may be used to form the surfaces 160, 162, and 174. For example, the counterbore 158 may be formed via a countersink or similar cutting tool, and the surface 174 may be formed via an angled or bevelled cutting tool. Other examples are possible.

The cartridge assembly 150 may include any number of packing members or toric joints (e.g., an O-ring) 182, 184 which may be adapted to be at least partially disposed within the recessed area. The packing members 182, 184 may be formed of any number of suitable materials. In some examples, the packing members 182, 184 have a generally circular cross section, but it is understood that the packing members 182, 184 may have cross sections of a different shape if so desired. Because the recessed area has generally inwardly-tapered sidewalls, at least approximately half of the circumference of the packing member 182 may be contained or encapsulated within the recessed area to prevent the packing member 182 from being easily removed without temporarily deforming or removing one of the components. As such, the packing member may be securely disposed within the recessed area and act as a seal. With reference again to FIG. 1, packing member 184 is disposed between the regulator body 102 and the retainer 152.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A fluid regulator, comprising:
a regulator body defining a fluid inlet, a fluid outlet, a fluid flow path connecting the fluid inlet to the fluid outlet, and an opening disposed in communication with the fluid flow path;
a retainer at least partially disposed within the opening of the regulator body, the retainer having a central bore extending along a longitudinal axis thereof and a counterbore formed along a first end of the central bore; and
a cartridge adapted to be at least partially disposed within the central bore of the retainer along the central longitudinal axis, the cartridge comprising an end portion having a surface extending radially from the central longitudinal axis;
wherein upon the cartridge being at least partially disposed within the central bore of the retainer, the counterbore of the retainer and the surface of the cartridge form a connecting groove.

2. The fluid regulator of claim 1, wherein the connecting groove comprises a dove-tail groove having an inner tapered projection and an outer tapered projection.

3. The fluid regulator of claim 1, further comprising a packing member adapted to be at least partially disposed within the connecting groove to act as a seal.

4. The fluid regulator of claim 1, wherein the surface of the cartridge comprises an exterior surface that is either planar, arcuate, or a combination thereof.

5. The fluid regulator of claim 4, wherein the surface extending radially from the central longitudinal axis forms an acute angle with the central longitudinal axis.

6. The fluid regulator of claim 1, wherein the end portion of the cartridge forms a generally beveled edge.

7. The fluid regulator of claim 1, wherein the counterbore of the retainer comprises a first surface and a second surface, wherein an angle formed between the first surface and the second surface of the counterbore is acute.

8. The fluid regulator of claim 3, wherein the connecting groove is dimensioned to allow at least 50% of a cross-sectional circumference of the packing member to be contained therein.

9. A regulator cartridge assembly comprising:
a retainer having a central bore extending along a longitudinal axis thereof and a notch surrounding an outer edge of the central bore;
a cartridge adapted to be at least partially disposed within the retainer along the central longitudinal axis via the central bore, the cartridge comprising an end portion having a surface protruding radially from the central longitudinal axis;
wherein the notch of the retainer and the surface of the cartridge are adapted to form a recessed area.

10. The regulator cartridge assembly of claim 9, wherein the recessed area comprises a groove having inwardly-tapered walls.

11. The regulator cartridge assembly of claim 9, wherein the end portion of the cartridge forms a generally beveled edge.

12. The regulator cartridge assembly of claim 9, further comprising a toric joint adapted to be at least partially disposed within the recessed area.

13. A method comprising:
providing a regulator body defining a fluid inlet, a fluid outlet, a fluid flow path connecting the fluid inlet to the fluid outlet, and an opening disposed in communication with the fluid flow path;
providing a retainer having a central bore extending along a longitudinal axis thereof and a counterbore formed along a first end of the central bore;
providing a cartridge having an end portion having a surface extending radially from the central longitudinal axis;
at least partially disposing the retainer within the opening of the regulator body; and
at least partially disposing the cartridge within the central bore of the retainer such that the counterbore of the retainer and the surface of the cartridge form a connecting groove.

14. The method of claim 13, further comprising the step of disposing a packing member in the connecting groove to form a seal.

15. The method of claim 13, wherein the step of providing the cartridge comprises forming a generally beveled edge on the end portion thereof.

16. The method of claim 13, wherein the step of providing the retainer comprises forming a counterbore having a tapered sidewall.

17. The method of claim 14, wherein the packing member is disposed in the connecting groove in a manner that at least approximately 50% of a cross-sectional circumference of the packing member is contained within the recessed area.
